(19) United States
(12) Patent Application Publication
(10) Pub. No.: US 2009/0006196 A1
(43) Pub. Date: Jan. 1, 2009

(54) Handheld communications device in system for and method of enhancing product selection and purchase in retail environments

(76) Inventors: Edward Barkan, Miller Place, NY (US); Mark Drzymala, Commack, NY (US)

Correspondence Address: KIRSCHSTEIN, OTTINGER, ISRAEL;& SCHIFFMILLER, P.C., 425 FIFTH AVENUE, 5TH FLOOR, NEW YORK, NY, 10016-2223, US

(21) Appl. No.: 11/823,816

(22) Filed: Jun. 28, 2007

(51) Int. Cl. G06Q 30/00; G06K 9/22

(52) U.S. Cl. 705/14; 705/1

(57) ABSTRACT

A system for, and method of, enhancing product selection and purchase in a retail environment, utilizes a handheld device that includes a cellular telephone operative for long-range, mobile, wireless communication over a wide cellular network, a solid-state imager having an array of image sensors for capturing return light from a target, and a communications interface operative for short-range, mobile, wireless communication over a local network associated with the retail environment. A controller is operatively connected to the telephone, the imager and the interface, and is operative for automatically pairing the handheld device with the local network by operating the imager to capture the return light from a command target code associated with the retail environment.

### DESCRIPTION OF THE RELATED ART

Recently, there has been an increased demand in the marketplace for increasing the capabilities of handheld, wireless, communication devices, such as portable cellular telephones, which conventionally include a speaker, a microphone, a display, and a data input device, such as a keypad. These telephones are typically used to initiate a voice call from one user to another user via the keypad. Once the voice call is initiated, the user positions the telephone in close proximity to his or her ear and mouth so as to listen to the speaker and speak into the microphone, i.e., communicate audibly, with the other user. It has been further proposed to send text messages from one user to another user via the keypad, and to enhance the microphone and speaker of the traditional cellular telephone with a speakerphone capability.

For increased capability, it has also been proposed to mount a camera in the cellular telephone including an imager, such as a charge coupled device (CCD) or a complementary metal oxide semiconductor (CMOS) device, to capture images, such as pictures of people and/or landscapes. It has been further proposed to mount a memory in the telephone, and to store songs, audio books, speeches, pictures, presentations, video and like audio-visual media in the memory for subsequent playback.

Other proposed multi-mode communication capabilities combine the cellular telephone with a personal digital assistant. In a first mode of operation, the device operates as a conventional cellular telephone. In a second mode of operation, the device operates as a personal digital assistant, and the user is permitted to, for example, write and store notes, view previously stored notes, fax a note, send or reply to a note via electronic mail, and/or access the Internet. In an overlapping shared mode, while viewing a stored note in the personal digital assistant mode, the user can place a telephone call and view the note during the call.

Still another capability built into cellular telephones is Bluetooth® technology, which is an industrial specification for wireless personal or local area networks (WPANs/WLANs). Bluetooth® technology provides a way to locally connect and exchange information between discrete devices, such as mobile phones, laptops, personal computers, printers, digital cameras, headsets, and video game consoles over a secure, globally unlicensed, short-range radio frequency. In a particularly popular application, a Bluetooth® —equipped cellular telephone is connected to a Bluetooth® —equipped automobile's sound system to enable a driver to talk to and hear another party without having to hold or manually dial the telephone.

As advantageous as using the Bluetooth® technology is in enhancing the safety of driving an automobile while talking on the telephone, Bluetooth® transmitting and receiving devices do not communicate with each other until they have been paired. The pairing operation usually requires manually entering data on the phone keypad, and is frequently performed by trained automotive personnel and is typically too complicated and inconvenient to be used in many other applications, for example, in retail marketing systems used by consumers as part of their product selection and purchasing process in retail environments.

### SUMMARY OF THE INVENTION

One feature of the present invention resides, briefly stated, in a system for, and a method of, enhancing product selection and purchase in a retail environment, by providing each customer with a handheld device including a cellular telephone operative for long-range, mobile, wireless communication over a wide cellular network of cell sites; a solid-state imager having a one- or two-dimensional array of image sensors, e.g., a CCD or CMOS array, operative, together with a focusing lens assembly, for capturing return light from a target; and a communications interface operative for short-range, mobile, wireless communication over a radio frequency (RF), e.g., Bluetooth® or Wi-Fi based on the IEEE 802.11 standard, or over an optical frequency, such as specified by the Infrared Data Association (IrDA), over a local network associated with the retail environment.

A programmed microprocessor or controller in the handheld device is operatively connected to the telephone, the imager and the short-range interface to control their operations. The controller controls the exposure time and read-out time of the imager and processes the captured image into electrical signals. In accordance with one aspect of this invention, the controller is also operative for automatically pairing the handheld device with the local network by operating the imager to capture the return light from a command target code or pairing tag associated with the retail environment. The return light may be ambient light, but preferably, especially when the imager is operated in low light or dark ambient environments, an illuminator is controlled by the controller for illuminating the target during image capture with illumination light directed from an illumination light source. The illumination light source comprises one or more light emitting diodes (LEDs).

The command target code advantageously comprises a symbol having parts of different light reflectivity and is located at a visible, accessible location in the retail environment. The controller decodes the electrical signals from the captured image and electro-optically reads the symbol. For example, the symbol can be located at each entrance to a retail store, or at kiosks or designated areas or departments within the store. The consumer takes a picture of the symbol using the imager and, as a result, the pairing operation is automatic and no longer requires manually entering data on a keypad of the telephone, or trained personnel. The handheld device is automatically unpaired with the local network when the short-range interface of the handheld device is moved out of range with the local network.

In a preferred embodiment, electronic representations of product discount coupons are loaded by the controller into an on-board memory for subsequent retrieval during product purchase. The controller may load the product discount coupons into the memory by operating the imager to capture the return light from printed coupon target codes and/or by downloading the electronic representations of the product discount coupons from an Internet site and/or by operating the cellular telephone to download the electronic representations of the product discount coupons from the wide cellular network and/or by operating the communications interface to download the electronic representations of the product discount coupons from the local network.

In another preferred embodiment, the controller is operative for loading electronic representations of product rebates from the local network via the communications interface into the memory during product purchase. The controller is thereupon operative for sending the electronic representations of the product rebates from the cellular telephone over the wide cellular network to a redeemer of the product rebates.

In yet another preferred embodiment, the controller obtains information, e.g., prices or nutritional information, about products being offered for purchase by operating the imager to capture the return light from product codes or product tags on the products, and is operative for displaying the obtained information on a display on the handheld device.

The controller may also control a shopping application stored in the memory on the handheld device, and is operative for obtaining prices about products selected for purchase by operating the imager to capture the return light from product codes on the selected products, and for displaying the prices on a display on the handheld device. The controller is also operative for checking the selected products out at a register by operating the imager to capture the return light from a register code or register tag on the register. In addition, the local network displays on the display any of the selected products requiring deactivation of an electronic surveillance tag.

In accordance with another aspect of this invention, the method of enhancing product selection and purchase in a retail environment is performed by supporting the cellular telephone operative for long-range, mobile, wireless communication over the wide cellular network in the handheld device; by supporting the solid-state imager having the array of image sensors for capturing return light from the target in the handheld device; by supporting the communications interface operative for short-range, mobile, wireless communication over the local network associated with the retail environment in the handheld device; and by automatically pairing the handheld device with the local network by operating the imager to capture the return light from the command target code associated with the retail environment.

In accordance with still another aspect of this invention, a communications device for enhancing product selection and purchase in a retail environment associated with a command target code, comprises a handheld housing; a cellular telephone in the housing and operative for long-range, mobile, wireless communication over a wide cellular network; a solid-state imager in the housing and having an array of image sensors for capturing return light from a target; a communications interface in the housing and operative for short-range, mobile, wireless communication over a local network associated with the retail environment; and a controller in the housing and operatively connected to the telephone, the imager and the interface, and operative for automatically pairing the handheld device with the local network by operating the imager to capture the return light from the command target code.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective, diagrammatic view of a cellular communications network operable with a handheld communications device in accordance with this invention;

FIG. 2 is an enlarged, perspective view of the handheld communications device of FIG. 1 in various modes of operation;

FIG. 3 is a block diagram view of the handheld communications device of FIG. 1 schematically depicting various components therein; and

FIG. 4 is a perspective view of a consumer holding the handheld communications device of FIG. 1 in a retail environment during a pairing mode of operation.

### DETAILED DESCRIPTION OF THE PREFERRED EMBODIMENTS

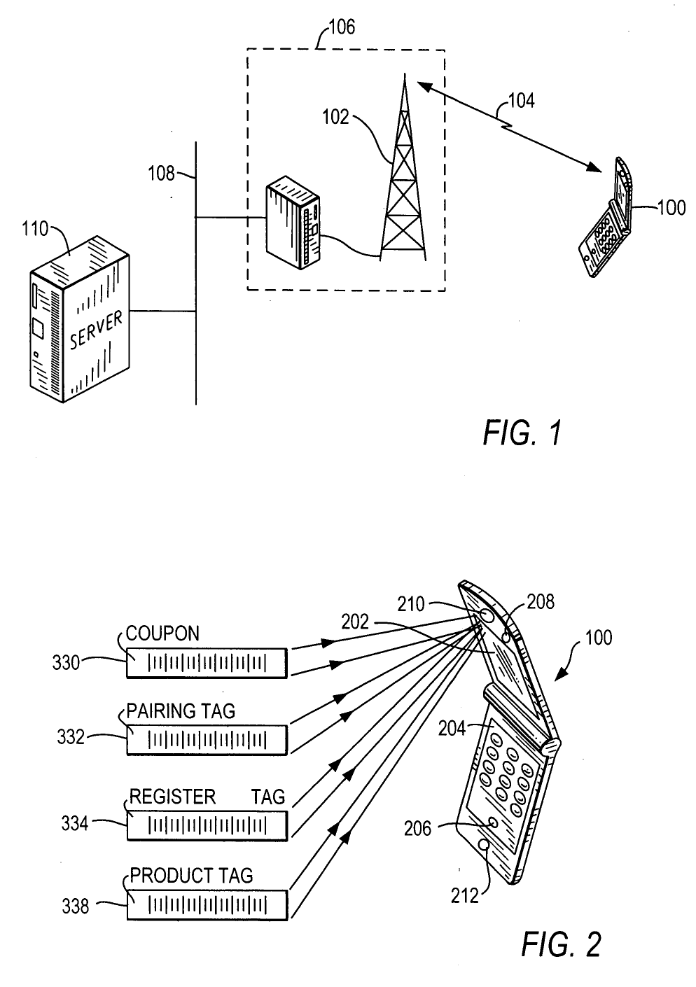

Referring to FIG. 1, a simplified cellular telephone network is depicted as being in radio frequency (RF) communication with a portable, wireless, handheld, communications device 100 capable of supporting one or more of a number of applications for the productivity and convenience of a user, including, among other things, Internet connectivity, normal voice/text traffic, and retail shopping, as described below. The cellular network is made up of a multitude of RF cells 106 each served by a fixed base, long-range transceiver 102 to transmit and receive RF signals 104 to and from the device 100. These cells 106 are used to cover different geographical areas in order to provide RF coverage over a wider area than the geographical area of just one cell. One or more cells 106 may be in wired or wireless communication with another network 108, e.g., the Internet, either public or private, to access a content or application server 110.

The device 100 includes a typical cellular telephone or handset such as those available from manufacturers, such as Motorola, Inc. The cells 106 are available as cellular infrastructure systems or Integrated Digital Enhanced Network equipment available from Motorola, Inc. The content or application server 110 is readily available from suppliers such as Dell, Inc. or Hewlett-Packard, Inc. and may operate as a server for Internet traffic using software such as Windows® from Microsoft Corporation. The network 108 is typically the Internet or an equivalent private packet network, whose makeup of routers from companies such as Cisco, Inc, and transmission equipment from companies such as Lucent, Inc. is well known.

Referring to FIG. 2, the device 100, just like a conventional cellular telephone, comprises a display 202, a keypad 204, a microphone 206 and a speaker 208. An embedded camera 210 is used to capture light from various targets, as described below. A short-range communications interface 212 is operative for wireless communication over a local network, especially one associated with a retail environment, again as described below.

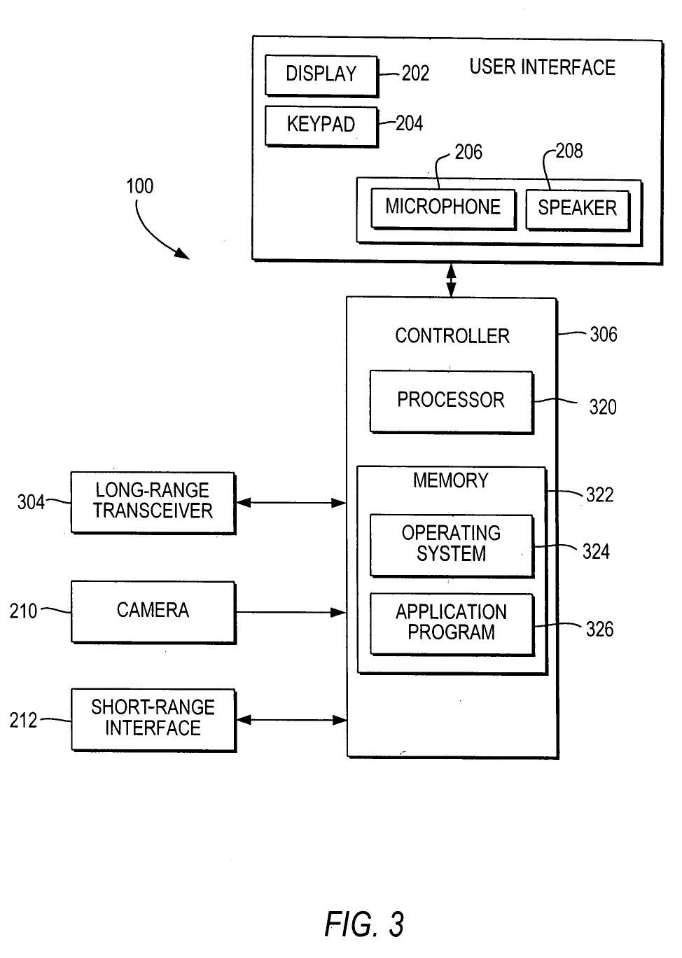

Referring to FIG. 3, the device 100 is comprised of several major functional components. A wireless, cellular, long-range transceiver 304 for receiving RF transmissions from the long-range cellular network, and for sending RF transmissions to the long-range cellular network, is coupled to, and controlled by, a controller 306. The controller 306 manages all the functions of the device 100, including the camera 210 and the short-range communications interface 212.

Coupled to the controller 306 is a user interface for interacting with a user of the device 100. The user interface is comprised of the display 202 which may be used for text or graphics or both. The display 202 may be monochrome, grayscale or color. If enabled for touch sensitivity, the display 202 may be used to capture the user's touch input as well. The keypad 204 is used to capture user input and is often numeric in nature with control keys for managing calls and data entry. The user interface also comprises an audio section for playing sounds through the speaker 208, and for capturing sounds such as spoken utterances through the microphone 206.

The controller 306 comprises a processor 320 for executing software instructions stored in a memory 322. The memory may comprise both volatile and non-volatile memory and may be partitioned into functional data blocks for an operating system 324 and application program(s) 326. In operation of the camera 210, the controller 306 sends a command signal to pulse the illuminator LEDs for a short time period, say 500 microseconds or less, and energizes the solid-state imager during an exposure time period of a frame to collect light from a target during said time period. A typical array needs about 33 milliseconds to read the entire target image and operates at a frame rate of about 30 frames per second. The array may have on the order of one million addressable image sensors.

The wireless transceiver 304 is available as discrete transmitter and receiver components or as a chipset from manufacturers, such as Motorola, Inc. The controller 306 is or may include a microprocessor or digital signal processor (DSP), each also available from Motorola, Inc. In some instances, the controller 306 may be another single chip processor such as an advanced risk machine (ARM) microcontroller manufactured by Motorola, Inc. and other semiconductor companies. The processor 320 and memory 322 are, in most cases, at least in part integral to the controller. Some elements of the memory 322 may be external to the controller 306. The elements of the user interface, including the display 202, the keypad 204, the speaker 208 and the microphone 206 are readily available from a variety of manufacturers and distributors.

As described above, it is generally known to provide cellular telephones with on-board cameras and Bluetooth® short-range transceivers especially in automotive applications, but not in retail establishments in which products are offered for purchase. It is also known in many industries, especially food retailers, to use a mobile, electro-optical reader, such as a moving laser beam-based scanner and a camera-based imaging reader, to read a symbol on the product to identify the product involved in a sales transaction. Once the product has been identified, its price can be retrieved from a database in order to complete a sales transaction.

In accordance with one aspect of this invention, the feature of the short-range transceiver 212 and the long-range transceiver 304, both interoperable with the feature of the camera 210 in a common handheld communications device 100, offer added incentives for consumers to shop in a retail environment that supports these features and enhance the consumer's product selection and purchase experience in the retail environment.

For example, many food retailers have offered redeemable coupons 330 as sales promotions to entitle the redeemers to discounts or refunds from the prices of the products being purchased. These coupons 330 have typically been printed on paper and distributed in newspapers, magazines, mass mailings and like publications. Sometimes, they are simply made available in a retail store for a shopper to pick up the paper coupon and present it to a checkout clerk for redemption. Recently, electronic coupons 330 have been made available on the Internet due to the relatively low cost of on-line distribution of coupons, as well as the capability of tracking the activity of users on the Internet and targeting the users with coupons that they are most likely to use. Such on-line, electronic coupons are typically printed out on the printer of each user and thereupon presented to a checkout clerk in the same manner as the paper coupons that were traditionally clipped from publications.

In accordance with another aspect of this invention, a consumer can download the electronic coupons or offers into her or his device 100 via the cellular telephone network, or from the Internet via a home computer using either an RF, optical or wired data link between the device 100 and the computer, or by scanning printed coupons 330 by using the camera 210, as shown in FIG. 2, from newspapers, printed advertisements, etc. A consumer could also subscribe to a service that periodically sends offers to his device 100 via the cellular telephone network. When the consumer visits a store, the coupon data would be transferred to the store's local area network, or to a kiosk in the store, by using the short-range Bluetooth® transceiver 212 in the device, thereby eliminating the requirement to physically clip, print, and present the coupon 330.

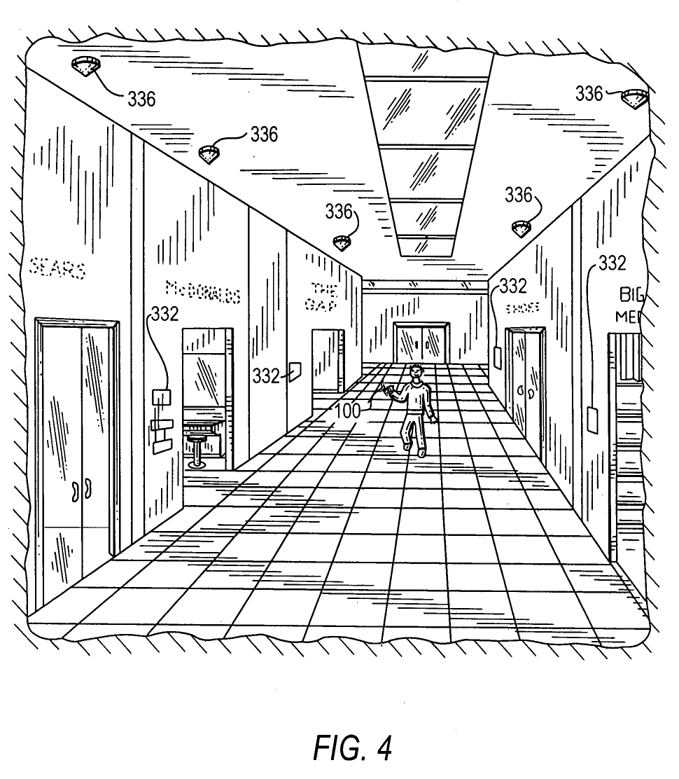

As previously described, Bluetooth® transceivers do not communicate with each other until they have been paired. The pairing operation usually requires manually entering data on the phone keypad 204, and is too inconvenient to be used for this kind of retail application. To make this kind of system user friendly, it is necessary to enable easy pairing of the Bluetooth® transceiver in the store to the Bluetooth® transceiver 212 in the device 100. This can be accomplished by associating a one- or two-dimensional symbol or pairing tag 332 with the retail store, e.g., at or near the store entrance (see FIG. 4), or at a kiosk or department in the store to pair the phone with the local area network of the store. The consumer scans the pairing tag 332 using the camera 210 in the device 100. When the pairing tag 332 has been decoded by the controller 306, communication and pairing between the device 100 and the local area network of the store will be automatically established. The pairing tag 332 contains whatever information is necessary for the device 100 to establish communication with the local area network or individual local transceiver.

Another possibility is to have the offers, advertising or information sent to the consumer's device 100 upon entering a store, or when the consumer moves into a particular area in the store. A consumer would have the ability to enable or disable reception of these offers via a menu displayed on the device's display 202, and selectable using the device's keypad 204. These offers are transmitted to the device 100 when the consumer comes within range of RF or optical beacons 336 (see FIG. 4) at the store.

Offers would be sent to the device 100 via the Bluetooth® (or equivalent) transceiver, or the Bluetooth® transceiver could send data indicating to the device that offers are available over the wide area cellular telephone network, at which time the device can download the offers if the consumer so desires. The in-store Bluetooth® transceiver would tell the device 100 whom to contact, over the wide area network, to get the offers. In either case, the device 100 could emit distinctive audible tones via speaker 208 to indicate that an offer has been received, or is available. Alternatively, a consumer can query the local beacon 336 or RF network, using the device 100, when interested in a product on display in the store (the product can be identified by scanning its product tag 338 by using the camera 210, as shown in FIG. 2), so as to receive information about the product, or to find out if any offers exist relating to that product or similar or related items.

Yet another possibility is for the device 100 to establish communication with the in-store local area network, and to communicate to the same, any offers carried in the device 100, that were gathered before or during the store visit. The in-store local area network would respond if products covered by those offers are present in the store, or if the store might be willing to provide a similar offer on a similar product. The in-store local area network could also supply information to the device which will help guide the consumer to the product of interest in the store. The in-store local area network could also make offers to consumers, to be stored in the consumer's device, that are redeemable upon a future visit, so as to entice the consumer to return. When a consumer wishes to redeem any of these offers, the device 100 is placed in communication with the in-store local area network which determines if the device contains offers on any products being purchased. If so, the offer is deleted from the device's memory 322 and the consumer receives his or her discount, or whatever else the offer included.

Some products are sold with rebates which require the consumer to mail in a form and a receipt to get a refund. The device 100 can eliminate this inconvenience by allowing the in-store local area network to load the rebate information into the device. The consumer can then electronically transmit that information to the manufacturer via the wide area network or through a home computer.

Once the consumer completes shopping and leaves the store, the pairing can be discontinued automatically, thereby breaking communication between the device and the in-store local area network. This can happen when the device goes out of range, or automatically when the application within the store is completed. If the device was formerly paired to something else, then that former pairing can be automatically restored when the device is back in range of the previously paired transceiver.

The device can also be paired with kiosks or Bluetooth® access points to allow the user to obtain information about products for sale in the store. In this case, the consumer would scan the product tag 338 on the product of interest using the camera 210. The Bluetooth® or similar short-range transceiver in the device would convey the scanned data to a nearby transceiver, or possibly over the wide area cellular telephone network, to a service provider who will return information such as specifications, nutritional information, etc., about the product that was scanned.

Another use for the device 100 is as a self-scanning/self-checkout system in a store. When a consumer enters a store, for example, a warehouse club, a supermarket or a drug store, the short-range transceiver 212 in the device establishes communication with the in-store local area network. This gives the device access to the store's price look-up file. The consumer selects a self-shopping application 326 from a menu on the display 202. This application may be already resident in the device, or may be downloaded to the device via the in-store local area network. or via the wide area cellular network, or from the Internet via a home computer, before going to the store.

The consumer then proceeds to scan products to be purchased as he or she walks around the store by using the camera 210 on the product tags 338, and places selected products into a shopping cart or shopping bag after scanning them. Each time a product is scanned, the device queries the store's price look-up file, and displays the price and description (if desired) of the product just scanned on the display 202, and adds that price to the total of all products already scanned, thereby maintaining a running total of the price of all the products in the shopping cart, thereby enabling a consumer to monitor his or her spending.

When all the selected products have been scanned and placed in the cart, the consumer goes to a cash register and scans a register tag 334 (see FIG. 2) on the register so the in-store local area network knows that the consumer is near that particular cash register. The scanned product data in the device is transmitted to the in-store local area network; a receipt is printed at that cash register; and the consumer pays. Payment can be automatic if credit or debit information is programmed into the device to be transmitted to the in-store local area network. For increased security, a PIN number may be required to be typed into the keypad 204 on the device, or into a keyboard provided by the store on a payment terminal. Of course, payment can also be made with cash, or by credit or debit card, in the conventional way. If the consumer has a frequent shopper card, that information can also be contained in the device and transmitted to the in-store local area network. This eliminates the need for the consumer to take any cards or cash out of his or her wallet to make the purchase.

If the device contains any coupons for products being purchased, that information can also be transmitted to the in-store local area network, and the price adjusted accordingly. The present invention can greatly speed up the checkout transaction. Checkout will be fast enough such that consumers buying large quantities of groceries can checkout at express lanes without inconveniencing other shoppers. Checkout can be made even more convenient by providing a supply of shopping bags hanging on hooks in the shopping cart, so that consumers can place the scanned products in the bags as the products are scanned.

Alternatively, consumers who intend to use their devices for self-scanning can pick up a supply of the shopping bags, and a bracket to hang the bags on in the cart, when the consumers arrive at the store. This avoids the need to bag the products at the checkout counter, so that the consumer can leave the store immediately after paying. This invention allows stores to supply the convenience of self-checkout to their customers, and also to minimize the number of cashiers, without having to buy expensive self-checkout systems, and without having to consume all of the space in the store that such systems require.

Consumers sometimes change their mind about what they want to buy. If this happens after a product has been scanned, then the consumer can return the product to the store shelf, and remove the product from a list of scanned products by pushing a designated button or sequence of buttons on the keypad 204.

Some products for sale in some stores include electronic article surveillance (EAS) tags that will need to be deactivated. When the consumer scans such an EAS-tagged product, the in-store local area network, which will have a record of all EAS-tagged products, can notify the consumer that such a product has been scanned and must be deactivated before leaving the store. A list of such products will be displayed on the display 202 so that the consumer can present them while at the checkout station. In addition, the list will be transmitted to the cash register where the consumer will be paying, and the cashier can request the EAS-tagged products for deactivation. For convenience, a shopper may wish to place EAS-tagged products in a shopping bag separate from un-tagged products so they can be easily located when checking out.

When the device 100 is used for self-checkout as described above, it would also be convenient to be able to create a shopping list that is carried in the memory 322. The consumer can read the list while in the store, and when products on the list are scanned, they will be automatically deleted from the list. If the device is in communication with the in-store local area network, the device can guide the consumer to the products on the list, and could even calculate an optimum path through the store to minimize travel time through the store to make shopping as fast as possible.

The shopping list can be created at home by scanning the product tags 338, using the camera 210 in the device, on products in the kitchen, for example, as they are consumed. Products that are not already in the home can be added to the shopping list by querying a remote database either using a home computer, or directly via the wide area cellular network. An application can run on the device that allows a consumer to search through various categories of groceries to find the one he or she is interested in. Once that product is found, the product can be added to the shopping list. The list, as stored in the memory 322, would include the product name for the consumer to see when looking at the list, and will also associate with each product name the Universal Product Code (UPC) number, which is not necessarily displayed to the consumer, but will be transmitted to the in-store local area network when the product is self-scanned in the store. The device will recognize that a product on the list has been scanned by comparing the UPC number of products as they are scanned, to the list of UPC numbers associated with the shopping list. If a match is found, then that product is deleted form the list. It will also e possible to delete products from the list manually.

As products are scanned in the store, and are subsequently deleted from the shopping list, they will be retained in a maser list which is also stored in the device's memory 322. This master list will retain the name and UPC number of every product that the consumer ever added to the shopping list. This allows the consumer to easily create a new shopping list, by scrolling through the master list before the next trip to the store, and clicking on products to be added to the new shopping list.

The device can store several master lists and several shopping lists for different kinds of stores. For example, there can be a supermarket list and there can be other lists for Target or Wal-mart Stores. New products can be added to the master list by scanning them in a store, or wherever a product might be found that a consumer might want to buy at a later date. The consumer can manually enter the name of the product, to be associated with the scanned UPC number, or can access a remote database of UPC numbers to look up the name. The remote database can be accessed in a store using Bluetooth® or similar short-range transceiver, at home via the Internet, by placing the device in communication with a home computer, or directly over the wide area cellular network.

Some stores provide home delivery service. The shopping list in the device can be transmitted to the service, for home delivery, by pressing a single button on the device after the shopping list has been accessed and edited, if necessary. The request for home delivery can be transmitted over the wide area cellular telephone network, or via the Internet using a home computer to which the device is connected, either by a wired or wireless interface.

It will be understood that each of the elements described above, or two or more together, also may find a useful application in other types of constructions differing from the types described above. Thus, readers having different configurations can be used.

While the invention has been illustrated and described as enhancing product selection and purchase in a retail environment using a handheld communications device, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

We claim:

1. A system for enhancing product selection and purchase in a retail environment, comprising:
a handheld device including a cellular telephone operative for long-range, mobile, wireless communication over a wide cellular network, a solid-state imager having an array of image sensors for capturing return light from a target, and a communications interface operative for short-range, mobile, wireless communication over a local network associated with the retail environment; and
a controller operatively connected to the telephone, the imager and the interface, and operative for automatically pairing the handheld device with the local network by operating the imager to capture the return light from a command target code associated with the retail environment.

2. The system of claim 1, wherein the short-range communications interface is operative at one of a radio frequency and an optical frequency.

3. The system of claim 1, wherein the handheld device has a memory, and wherein the controller is operative for loading electronic representations of product discount coupons into the memory for subsequent retrieval during product purchase.

4. The system of claim 3, wherein the controller loads the product discount coupons into the memory by operating the imager to capture the return light from printed coupon target codes.

5. The system of claim 3, wherein the controller loads the product discount coupons into the memory by downloading the electronic representations of the product discount coupons from an Internet site.

6. The system of claim 3, wherein the controller loads the product discount coupons into the memory by operating the cellular telephone to download the electronic representations of the product discount coupons from the wide cellular network.

7. The system of claim 3, wherein the controller loads the product discount coupons into the memory by operating the communications interface to download the electronic representations of the product discount coupons from the local network.

8. The system of claim 1, wherein the handheld device has a memory, wherein the controller is operative for loading electronic representations of product rebates from the local network via the communications interface into the memory during product purchase, and wherein the controller is operative for sending the electronic representations of the product rebates from the cellular telephone over the wide cellular network to a redeemer of the product rebates.

9. The system of claim 1, wherein the command target code comprises a symbol having parts of different light reflectivity and located at a visible, accessible location in the retail environment.

10. The system of claim 1, wherein the handheld device is automatically unpaired with the local network when the communications interface of the handheld device is moved out of range with the local network.

11. The system of claim 1, wherein the handheld device has a display, and wherein the controller obtains information about products being offered for purchase by operating the imager to capture the return light from product codes on the products, and is operative for displaying the obtained information on the display.

12. The system of claim 1, wherein the controller controls a shopping application stored in a memory on the handheld device, and is operative for obtaining prices about products selected for purchase by operating the imager to capture the return light from product codes on the selected products, and for displaying the prices on a display on the handheld device, and wherein the controller is operative for checking the selected products out at a register by operating the imager to capture the return light from a register code on the register.

13. The system of claim 12, wherein the local network displays on the display any of the selected products requiring deactivation of an electronic surveillance tag.

14. A method of enhancing product selection and purchase in a retail environment, comprising the steps of:
supporting a cellular telephone operative for long-range, mobile, wireless communication over a wide cellular network in a handheld device;
supporting a solid-state imager having an array of image sensors for capturing return light from a target in the handheld device;
supporting a communications interface operative for short-range, mobile, wireless communication over a local network associated with the retail environment in the handheld device; and
automatically pairing the handheld device with the local network by operating the imager to capture the return light from a command target code associated with the retail environment.

15. The method of claim 14, and configuring the short-range communications interface to be operative at one of a radio frequency and an optical frequency.

16. The method of claim 14, and loading electronic representations of product discount coupons into a memory in the handheld device for subsequent retrieval during product purchase.

17. The method of claim 16, wherein the loading step is performed by operating the imager to capture the return light from printed coupon target codes.

18. The method of claim 16, wherein the loading step is performed by downloading the electronic representations of the product discount coupons from an Internet site.

19. The method of claim 16, wherein the loading step is performed by operating the cellular telephone to download the electronic representations of the product discount coupons from the wide cellular network.

20. The method of claim 16, wherein the loading step is performed by operating the communications interface to download the electronic representations of the product discount coupons from the local network.

21. The method of claim 14, and loading electronic representations of product rebates from the local network via the communications interface into a memory of the handheld device during product purchase, and sending the electronic representations of the product rebates from the cellular telephone over the wide cellular network to a redeemer of the product rebates.

22. The method of claim 14, and configuring the command target code to be a symbol having parts of different light reflectivity, and locating the symbol at a visible, accessible location in the retail environment.

23. The method of claim 14, and automatically unpairing the handheld device with the local network by moving the communications interface of the handheld device out of range with the local network.

24. The method of claim 14, and obtaining information about products being offered for purchase by operating the imager to capture the return light from product codes on the products, and displaying the obtained information on a display on the handheld device.

25. The method of claim 14, and obtaining prices about products selected for purchase by operating the imager to capture the return light from product codes on the selected products, and displaying the prices on a display on the handheld device, and checking the selected products out at a register by operating the imager to capture the return light from a register code on the register.

26. The method of claim 25, and displaying on the display any of the selected products requiring deactivation of an electronic surveillance tag.

27. A communications device for enhancing product selection and purchase in a retail environment associated with a command target code, comprising:
a handheld housing;
a cellular telephone in the housing and operative for long-range, mobile, wireless communication over a wide cellular network;
a solid-state imager in the housing and having an array of image sensors for capturing return light from a target;
a communications interface in the housing and operative for short-range, mobile, wireless communication over a local network associated with the retail environment; and
a controller in the housing and operatively connected to the telephone, the imager and the interface, and operative for automatically pairing the handheld device with the local network by operating the imager to capture the return light from the command target code.

28. The device of claim 27, wherein the short-range communications interface is operative at one of a radio frequency and an optical frequency.

29. The device of claim 27, wherein the handheld housing has a memory, and wherein the controller is operative for loading electronic representations of product discount coupons into the memory for subsequent retrieval during product purchase.

30. The device of claim 29, wherein the controller loads the product discount coupons into the memory by operating the imager to capture the return light from printed coupon target codes.

31. The device of claim 29, wherein the controller loads the product discount coupons into the memory by downloading the electronic representations of the product discount coupons from an Internet site.

32. The device of claim 29, wherein the controller loads the product discount coupons into the memory by operating the cellular telephone to download the electronic representations of the product discount coupons from the wide cellular network.

33. The device of claim 29, wherein the controller loads the product discount coupons into the memory by operating the communications interface to download the electronic representations of the product discount coupons from the local network.

34. The device of claim 27, wherein the handheld housing has a memory, wherein the controller is operative for loading electronic representations of product rebates from the local network via the communications interface into the memory during product purchase, and wherein the controller is operative for sending the electronic representations of the product rebates from the cellular telephone over the wide cellular network to a redeemer of the product rebates.

35. The device of claim 27, wherein the command target code comprises a symbol having parts of different light reflectivity and located at a visible, accessible location in the retail environment.

36. The device of claim 27, wherein the handheld housing is automatically unpaired with the local network when the communications interface of the handheld housing is moved out of range with the local network.

37. The device of claim 27, wherein the handheld housing has a display, and wherein the controller obtains information about products being offered for purchase by operating the imager to capture the return light from product codes on the products, and is operative for displaying the obtained information on the display.

38. The device of claim 27, wherein the controller controls a shopping application stored in a memory on the handheld housing, and is operative for obtaining prices about products selected for purchase by operating the imager to capture the return light from product codes on the selected products, and for displaying the prices on a display on the handheld housing, and wherein the controller is operative for checking the selected products out at a register by operating the imager to capture the return light from a register code on the register.

39. The device of claim 38, wherein the local network displays on the display any of the selected products requiring deactivation of an electronic surveillance tag.
